(19) United States
(12) Patent Application Publication
(10) Pub. No.: US 2022/0106748 A1
(43) Pub. Date: Apr. 7, 2022

(54) TRAFFIC CONE ASSEMBLIES AND METHODS OF MANUFACTURE

(71) Applicant: Hill & Smith Inc., Columbus, OH (US)

(72) Inventor: Jeffery D. Smith, St. Charles, IL (US)

(21) Appl. No.: 17/496,347

(22) Filed: Oct. 7, 2021

Related U.S. Application Data
(60) Provisional application No. 63/088,997, filed on Oct. 7, 2020.

(51) Int. Cl. E01F 9/654; E01F 9/688; C08K 5/12; C08K 5/11; C08K 5/37

(52) U.S. Cl. CPC E01F 9/654; E01F 9/688; C08K 2201/014; C08K 5/11; C08K 5/37; C08K 5/12

(57) ABSTRACT

Traffic cone assemblies include a first wall portion disposed at an acute angle relative to a longitudinal axis to at least partially defines a hollow interior of the traffic cone assembly. The first wall portion includes polyvinyl chloride as well as first, second and third plasticizers each in an amount of 10-20 parts by weight per 100 parts by weight of polyvinyl chloride. The first wall portion also includes a heat stabilizer in an amount of 1-5 parts by weight per 100 parts by weight of polyvinyl chloride, and a first colorant in an amount of 0.5-2 parts by weight per 100 parts by weight of polyvinyl chloride. Additionally, or in the alternative, traffic cone assemblies include a body section and a base section. The body section includes with first, second and third wall portions. Methods of manufacture are also included.

This application claims the benefit of priority to U.S. Provisional Patent Application Ser. No. 63/088,997, filed on Oct. 7, 2020, the content of which is hereby incorporated herein by reference in its entirety.

### BACKGROUND

The subject matter of the present disclosure broadly relates to the art of safety and area demarcation products and, more particularly, to traffic and marking cone assemblies as well as methods of manufacturing the same.

Area demarcation products are well known and commonly used to control and/or redirect vehicle and/or pedestrian traffic in and around indoor and/or outdoor areas. In many cases, such products take the form of a square or rectangular base with a conical body that extends upward from the base. At least the conical body will often have a high-visibility exterior color so that the area demarcation product is easily observed. Such area demarcation products are commonly referred to as traffic cones, but can also be referred to as pylons, safety cones, or simply “cones”. For purposes of clarity and ease of reading, area demarcation products of the subject disclosure will be referred to herein by terms such as “traffic cone”, “traffic cones”, “traffic cone assembly” and/or “traffic cone assemblies” irrespective of and without limitation on the type and/or kind of application and/or use for which the area demarcation products may be deployed, which can—as non-limiting examples—also include use for sports practices, driving instruction and pet training. Though use for an extended duration is entirely possible, conventional traffic cones are commonly deployed on a temporary basis, such as to redirect roadway or pedestrian traffic and/or for periods of practice, instruction and/or training in non-traffic types of activities.

It will be appreciated that application and use in restricting and/or redirecting vehicle traffic can subject traffic cones to potential impact by vehicles traveling at speeds from a few miles per hour (MPH) to highway speeds (e.g., 70 MPH). Additionally, it will be appreciated that when used in such traffic-related applications, traffic cones can be subjected to weather conditions ranging from very cold temperatures (e.g., below negative twenty five (−25) degrees Celsius) during the winter to very high temperatures (e.g., above fifty (50) degrees Celsius) during the summer. Furthermore, traffic cones are also exposed to ultraviolet rays during use in outdoor applications, which tends to degrade polymeric materials over time. Development of traffic cones that are durable and capable of withstanding vehicle impacts over a wide range of temperatures and other environmental conditions represents an ongoing challenge.

As such, notwithstanding the ubiquitous usage and overall success of known types and kinds of traffic cone constructions, it is believed desirable to develop traffic cone assemblies and methods of manufacture that may aid in overcoming the foregoing and/or other problems and/or disadvantages of known traffic cones, and/or otherwise advance the art of safety and area demarcation products.

### BRIEF DESCRIPTION

One example of a traffic cone assembly in accordance with the subject matter of the present disclosure can have a longitudinal axis and can include a first wall portion extending peripherally about the longitudinal axis and between a first end and a second end that is spaced longitudinally from the first end. The first wall portion can be disposed at an acute angle relative to the longitudinal axis such that the first wall portion includes a frustoconical outer surface portion and an inner surface portion that at least partially defines a hollow interior of the traffic cone assembly. The first wall portion can include polyvinyl chloride, a first plasticizer in an amount of 10-20 parts by weight per 100 parts by weight of polyvinyl chloride, a second plasticizer in an amount of 10-20 parts by weight per 100 parts by weight of polyvinyl chloride, a third plasticizer in an amount of 10-20 parts by weight per 100 parts by weight of polyvinyl chloride, a heat stabilizer in an amount of 1-5 parts by weight per 100 parts by weight of polyvinyl chloride, and a first colorant in an amount of 0.5-2 parts by weight per 100 parts by weight of polyvinyl chloride

Another example of a traffic cone assembly in accordance with the subject matter of the present disclosure can, alone or in combination with the features of the foregoing paragraph, include a body section having a longitudinal axis. The body section can include a body wall extending longitudinally between a first end and a second end. The body wall can include a first wall portion disposed along the first end with a first outer surface portion at least partially defining a grasping area of the body section. A second wall portion can extend from along the first wall portion toward the second end at an acute angle relative to the longitudinal axis such that the second wall portion includes a frustoconical outer surface portion and a frustoconical inner surface portion that at least partially defines an interior cavity of the body section. A third wall portion can extend radially outward from the second wall portion along the second end to an outer peripheral edge surface portion. The third wall portion can include a first end surface portion facing toward the first end and a second end surface portion facing toward the second end. The third wall portion can also include a first intermediate end surface portion facing toward the first end that is offset from the first end surface portion in a direction toward the second end surface portion. The third wall portion can further include a second intermediate end surface portion facing toward the second end that is offset from the second end surface portion in a direction toward the first end surface portion. A base section can include a base wall with a first base end surface facing toward the first end of the body section and a second base end surface facing away from the first end of the body section. The base wall can extend outward to an outermost peripheral edge and can include a first base wall portion extending along the first intermediate end surface portion of the body wall and a second base wall portion extending along the second intermediate end surface portion of the body wall such that at least part of the third wall portion of the body wall is substantially encapsulated by the base wall thereby operatively connecting the base section to the body section.

One example of a method of manufacturing a traffic cone assembly in accordance with the subject matter of the present disclosure can include providing a first mold body with a longitudinal axis. The first mold body can include a first mold cavity defined by a first tooling surface shaped to provide a first wall portion that can extend between a first end and a second end spaced longitudinally from the first end. The first wall portion can be disposed at an acute angle relative to the longitudinal axis such that the first wall portion includes a frustoconical outer surface portion and an inner surface portion that at least partially defines a hollow interior of the first wall portion. The method can also include introducing a first material composition into the first mold cavity to at least partially form the first wall portion. The first material composition can include polyvinyl chloride, a first plasticizer in an amount of 10-20 parts by weight per 100 parts by weight of polyvinyl chloride, a second plasticizer in an amount of 10-20 parts by weight per 100 parts by weight of polyvinyl chloride, a third plasticizer in an amount of 10-20 parts by weight per 100 parts by weight of polyvinyl chloride, a heat stabilizer in an amount of 1-5 parts by weight per 100 parts by weight of polyvinyl chloride, and a first colorant in an amount of 0.5-2 parts by weight per 100 parts by weight of polyvinyl chloride. The method can also include removing the first wall portion from the mold cavity.

### BRIEF DESCRIPTION OF THE DRAWINGS

FIG. 1 is a top perspective view of one example of a traffic cone assembly in accordance with the subject matter of the present disclosure.

FIG. 2 is a bottom perspective view of the exemplary traffic cone assembly in FIG. 1.

FIG. 3 is a top plan view of the exemplary traffic cone assembly in FIGS. 1 and 2.

FIG. 4 is a bottom plan view of the exemplary traffic cone assembly in FIGS. 1-3.

FIG. 5 is a side elevation view of the exemplary traffic cone assembly in FIGS. 1-4.

FIG. 6 is a cross-sectional view of the exemplary traffic cone assembly in FIGS. 1-5 taken from along line 6-6 in FIG. 4.

FIG. 7 is an enlarged, top perspective view of the exemplary traffic cone assembly in FIGS. 1-6 with a portion of the base section shown cut away.

FIG. 8 is an enlarged, top plan view of the exemplary traffic cone assembly in FIGS. 1-7 with the portion of the base section in FIG. 7 shown cut away.

FIG. 9 is an enlarged, bottom perspective view of the exemplary traffic cone assembly in FIGS. 1-8 with the portion of the base section in FIGS. 7 and 8 shown cut away.

FIG. 10 is an enlarged, bottom plan view of the exemplary traffic cone assembly in FIGS. 1-9 with the portion of the base section in FIGS. 7-9 shown cut away.

FIG. 11 is an enlarged view of the portion of the cone section of the traffic cone assembly in FIGS. 1-10 identified as Detail 11 in FIG. 10.

FIG. 12 is an enlarged view of the portion of the traffic cone assembly in FIGS. 1-11 identified as Detail 12 in FIG. 6.

FIG. 13 is an enlarged view of the portion of the traffic cone assembly in FIGS. 1-12 identified as Detail 13 in FIG. 6.

### DETAILED DESCRIPTION

Turning now to the drawings, it is to be understood that the showings are for purposes of illustrating examples of the subject matter of the present disclosure and that the same are not intended to be limiting. Additionally, it will be appreciated that the drawings are not to scale and that portions of certain features and/or elements may be exaggerated for purpose of clarity and/or ease of understanding.

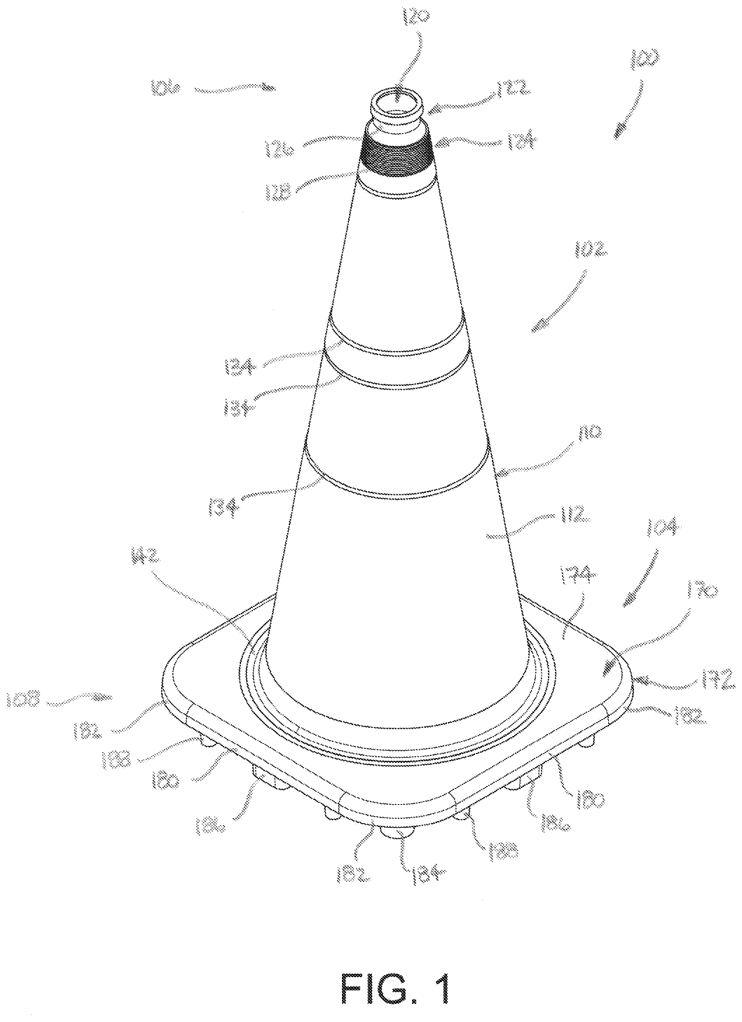

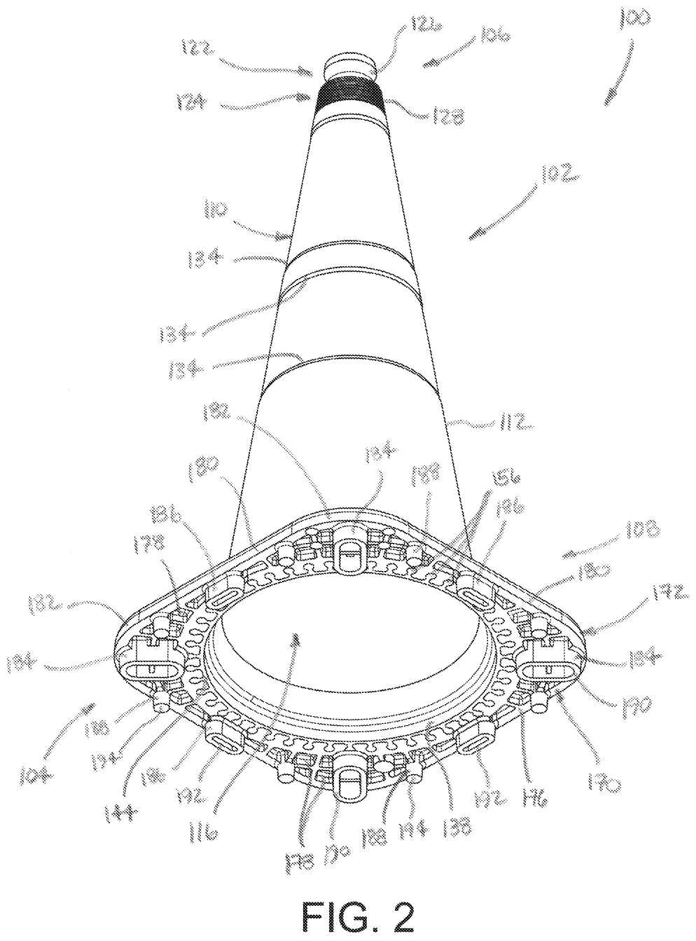

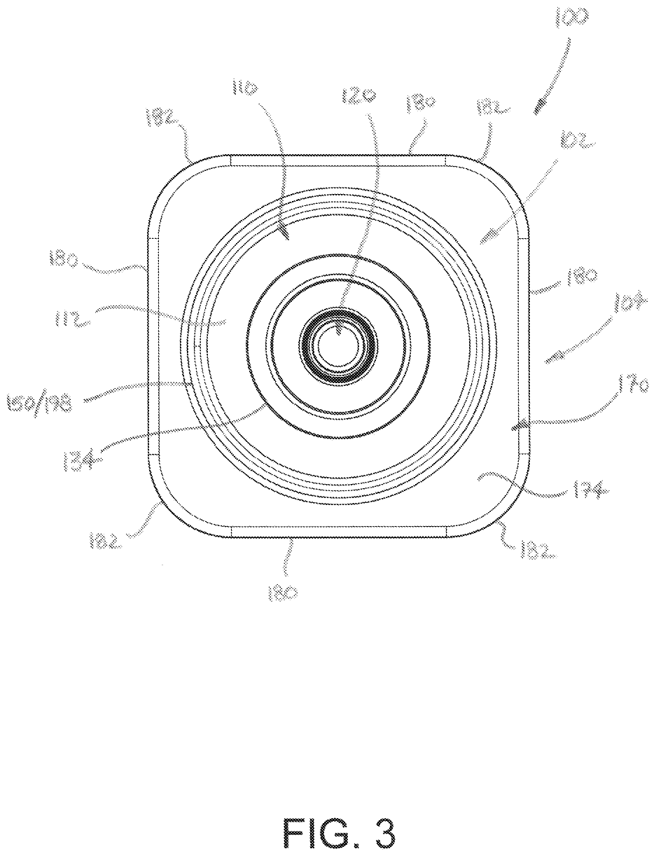

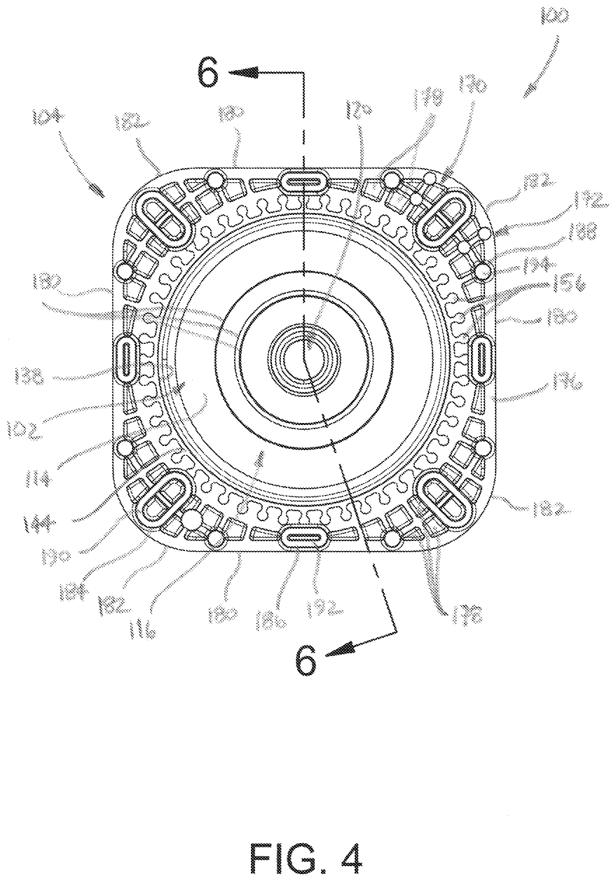

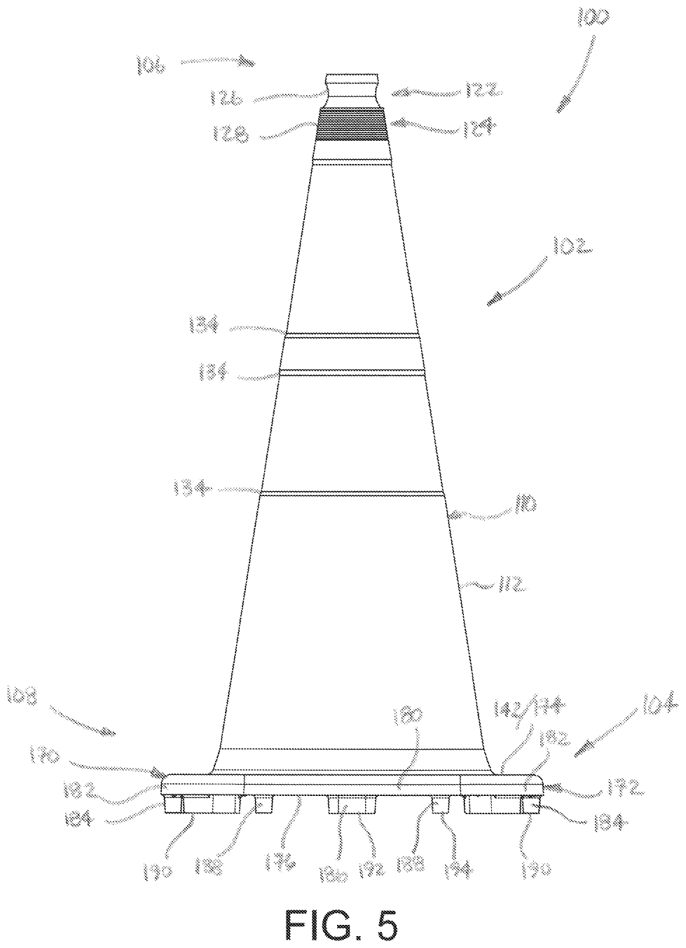

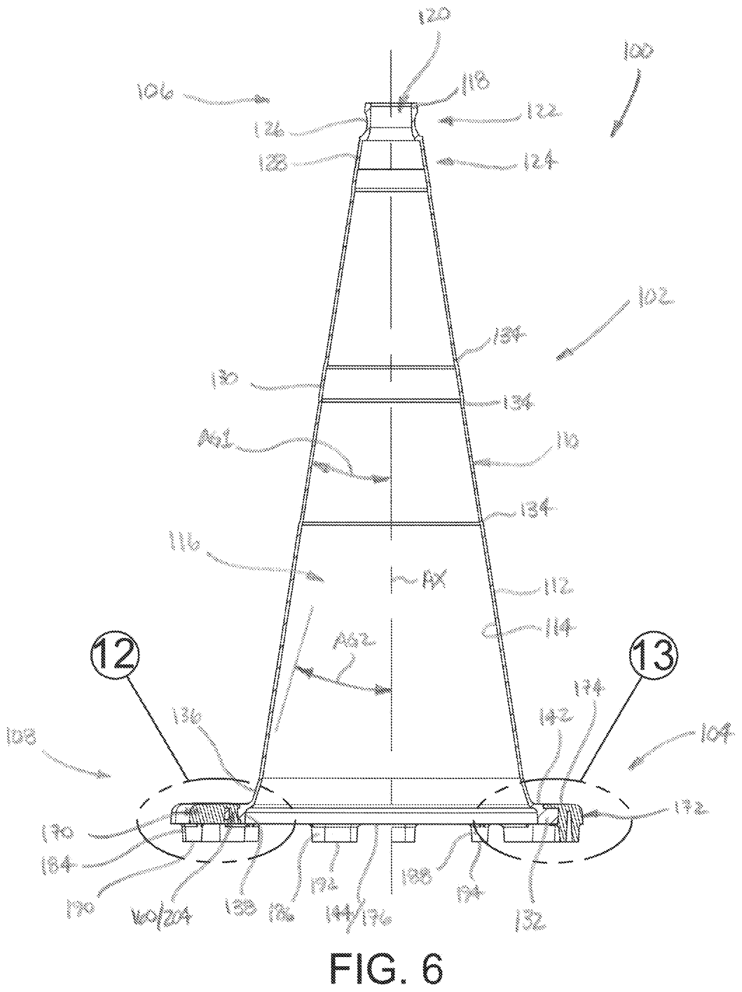

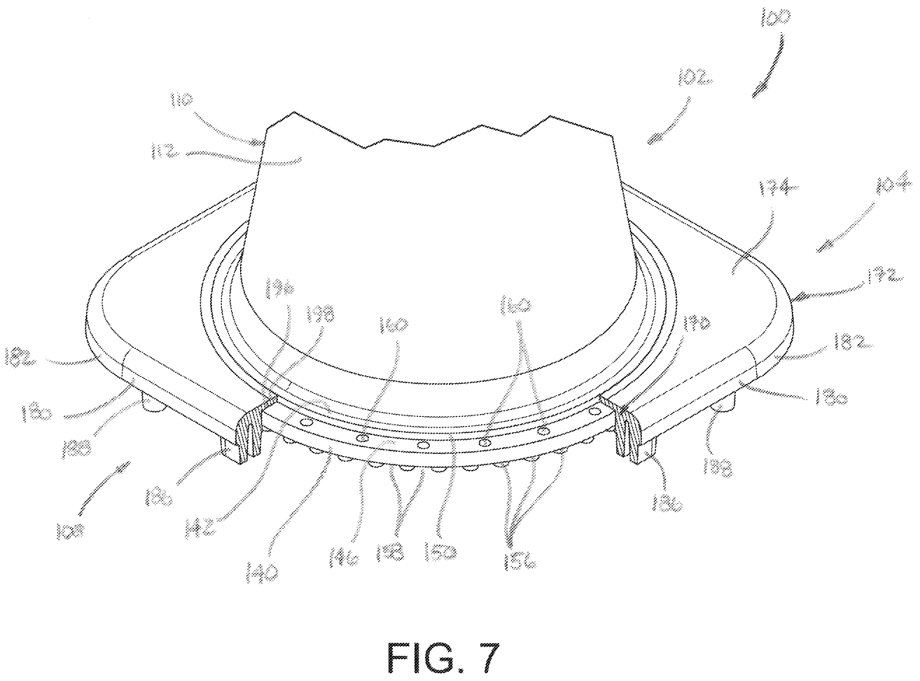

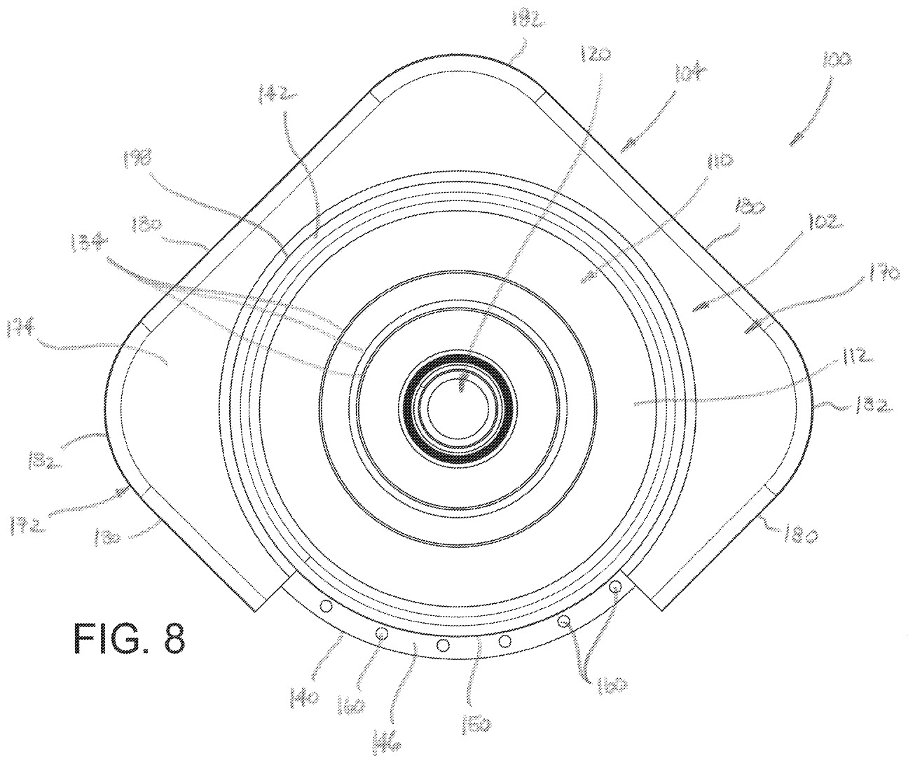

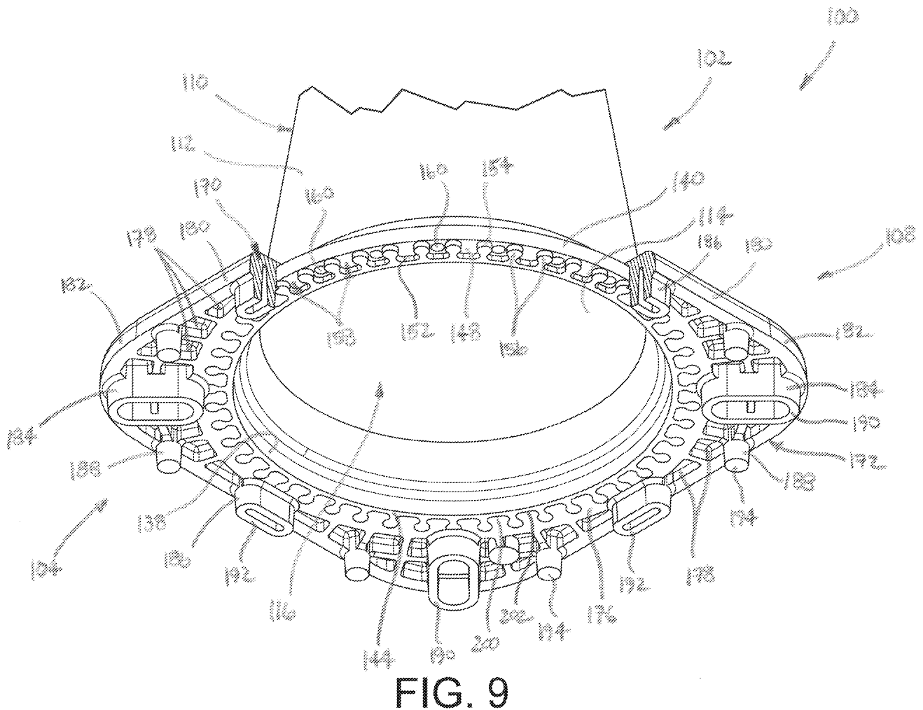

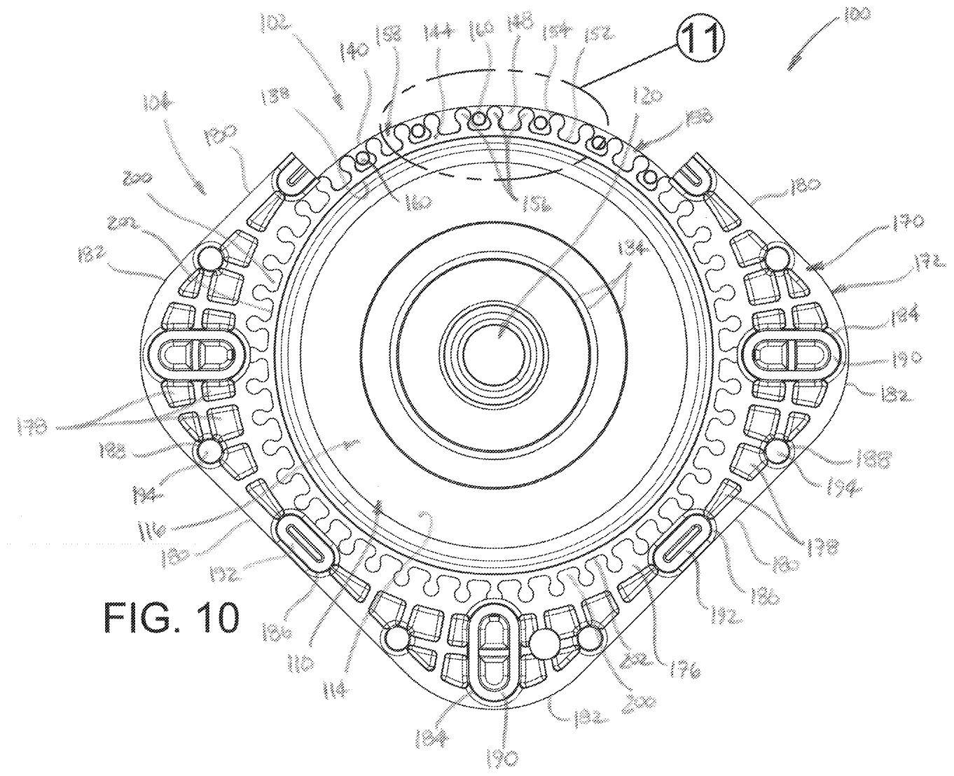

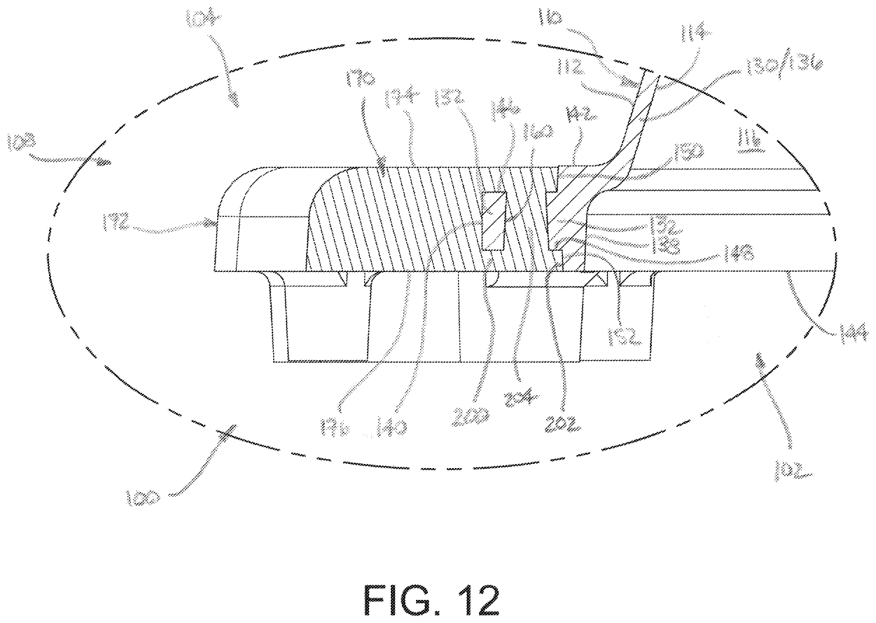

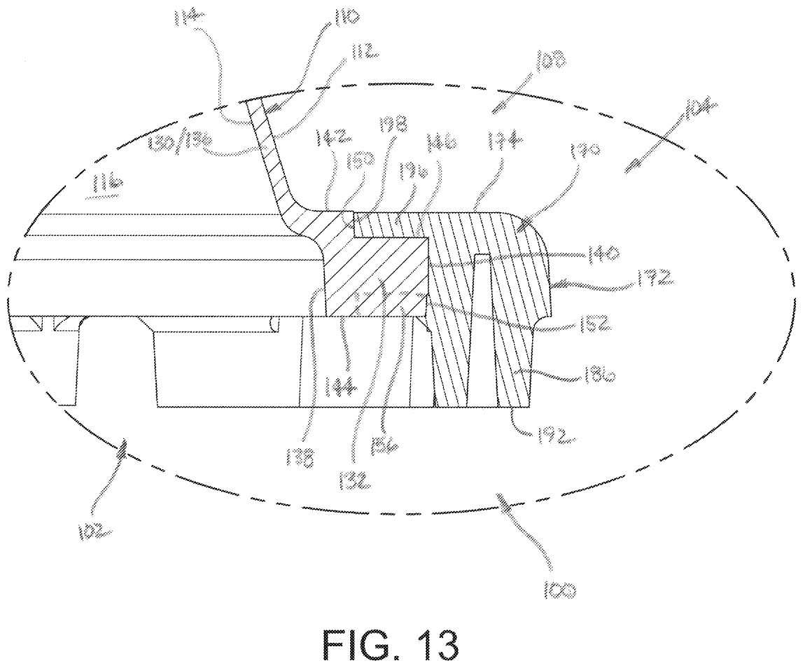

FIGS. 1-13 illustrate one example of a traffic cone assembly 100 in accordance with the subject matter of the present disclosure. Traffic cone assembly 100 can include a cone body (or body section) 102 and a cone base (or base section) 104. Traffic cone assembly 100 includes a longitudinal axis AX (FIG. 6) and extends between an end 106 and an end 108 that are spaced longitudinally from one another. Body section 102 includes a body wall 110 that extends peripherally about longitudinal axis AX and longitudinally from along first end 106 toward second end 108. Body wall 110 includes an outer surface portion 112 facing outward and an inner surface portion 114 facing opposite the outer surface portion to at least partially define an interior cavity 116 of traffic cone assembly 100. Body wall 110 includes a wall portion 118 disposed along or toward end 106 that can, optionally, at least partially define an opening 120 along end 106. Wall portion 118 can include one or more features and/or arrangements that can at least partially define a grasping area 122 and/or a grasping area 124 of traffic cone assembly 100 on or along end 106. For example, wall portion 118 can include a non-linear outer surface profile segment 126 with a concave shape that at least partially defines grasping area 122 as an annular groove. As another example, wall portion 118 can include an outer surface profile segment 128 with one or more V-shaped notches that extend annularly and/or helically around longitudinal axis AX to at least partially define grasping area 124 by one or more grooves or threads.

Body wall 110 also includes a wall portion 130 that extends from along wall portion 118 to a wall portion 132 disposed on, along or otherwise toward end 108 of the traffic cone assembly. Wall portion 130 extends peripherally around longitudinal axis AX at an acute angle, which is represented in FIG. 6 by angular dimension AG1, such that the wall portion has an approximately frustoconical shape and/or configuration. In some cases, the wall portion can have a substantially linear cross-sectional profile and/or shape forming substantially uniform and continuous inner and outer surface portions 110 and 112. In other cases, wall portion 132 can include two or more cross-sectional profile sections that are radially offset from one another. In such cases, one or more shoulders or steps 134 can be positioned on or along wall portion 132 between wall portions 118 and 132. In some cases, a wall portion 136 can be disposed between wall portions 130 and 132 that is disposed at an acute angle relative to longitudinal axis AX that is different from the acute angle of wall portion 130, as is represented in FIG. 6 by angular dimension AG2.

Wall portion 132 includes an inner peripheral edge surface portion 138 disposed along or adjacent wall portion 130 and extends radially outward an outer peripheral edge surface portion 140. In some cases, inner peripheral edge surface portion 138 can be offset radially outward from inner surface portion 114 extending along wall portion 130, such as to provide additional clearance when a plurality of traffic cone assemblies of the same or different types and/or constructions are stacked together. Additionally, wall portion 132 includes an end surface portion 142 facing toward end 106 and an end surface portion 144 facing toward end 108. Wall portion 132 can include one or more intermediate end surface portions that are offset from end surface portions 142 and/or 144. Additionally, or in the alternative, wall portion 132 can include one or more intermediate peripheral edge surface portions that are disposed radially along and/or between the inner and outer peripheral edge surface portions. In such cases, it will be appreciated that such an intermediate peripheral edge surface portion can extend axially into wall portion 132 from along end surface portion 142 or end surface portion 144 toward a corresponding intermediate end surface portion.

In the exemplary arrangement shown herein, an intermediate end surface portion 146 can be disposed in offset alignment with end surface portion 142 and an intermediate end surface portion 148 can be disposed in offset alignment with end surface portion 144. In such an arrangement, end surface portion 142 and intermediate end surface portion 146 can face toward end 106 with end surface portion 144 and intermediate end surface portion 148 facing toward end 108. Wall portion 132 is also shown as including an intermediate peripheral edge surface portion 150 that extends from along end surface portion 142 toward intermediate end surface portion 146. Wall portion 132 can also include an intermediate peripheral edge surface portion 152 that extends from along end surface portion 144 toward intermediate end surface portion 148. Intermediate peripheral edge surface portions 150 and/or 152 can be disposed radially between inner peripheral edge surface portion 138 and outer peripheral edge surface portion 140. It will be appreciated that intermediate peripheral edge surface portions 150 and 152 can be of any suitable configuration and/or arrangement. As one non-limiting example, intermediate peripheral edge surface portions 150 and/or 152 can have an approximately cylindrical shape.

As another non-limiting example, intermediate peripheral edge surface portions 150 and/or 152 can include a non-circular cross-sectional shape, when taken transverse to longitudinal axis AX. In the exemplary arrangement shown and described herein, intermediate peripheral edge surface portion 150 is shown as including an approximately cylindrical shape with intermediate peripheral edge surface portion 152 shown as including a non-circular cross-sectional shape. It is to be specifically recognized and understood that such an arrangement is merely exemplary and not intended as a limitation and that either or both of intermediate peripheral edge surface portions 150 and 152 could include a non-circular cross-sectional shape.

In the exemplary arrangement shown and described herein, intermediate peripheral edge surface portion 152 includes a non-circular cross-sectional shape formed from a contoured surface segment 154 disposed in a repeating pattern around longitudinal axis AX. Contoured surface segments 154 are disposed in spaced relation to one another about longitudinal axis AX such that the plurality of plurality of contoured surface segments form a plurality of lobes 156 extending axially from along intermediate end surface portion 148 and radially outward from along inner peripheral edge surface portion 138. The plurality of contoured surface segments and corresponding plurality of lobes 156 are disposed in spaced relation to one another around longitudinal axis AX such that a plurality of spaces 158 are disposed around the longitudinal axis with one space disposed between two adjacent ones of the plurality of lobes. Additionally, a plurality of openings or passages 160 are disposed in peripherally-spaced relation to one another about longitudinal axis AX. In a preferred arrangement, passages 160 extend through wall portion 132 between intermediate end surface portions 146 and 148, such as within one of spaces 158 between adjacent ones of lobes 156. In some cases, the plurality of passages can be less than the plurality of spaces such that one or more spaces are disposed between adjacent ones of passages 160. In such cases, two or more of lobes 156 can be disposed between adjacent ones of passages 160.

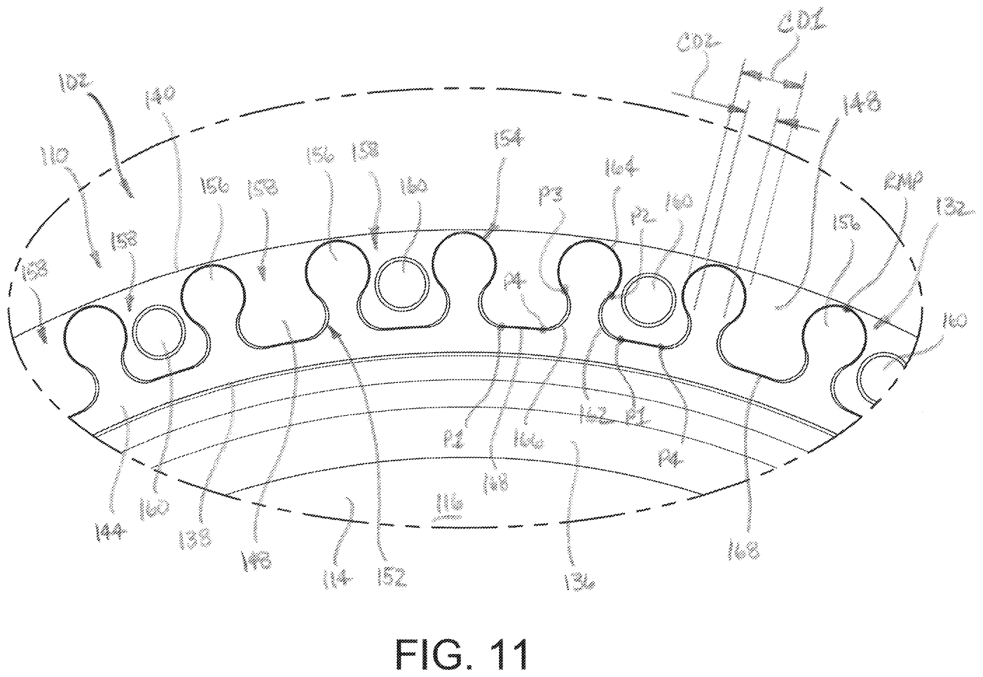

Contoured surface segments 154 can include a plurality of contoured profile sections that together at least partially define the overall configuration and/or shape of the contoured surface segment. As a non-limiting example, contoured surface segments 154 can include a first profile section 162 has a concave shape and extends from a profile point P1 to a profile point P2. A second profile section 164 has a convex shape and extends from profile point P2 to a profile point P3. A third profile section 166 has a concave shape, which can—in some cases—be substantially similar to the concave shape of first profile section 162, and extends from profile point P3 to a profile point P4. Adjacent ones of contour surface segments 154 can be connected by a radial profile section 168 that can extend between profile point P4 of one contoured surface segment and profile point P1 of an adjacent surface segment. In some cases, second profile section 164 can have a maximum cross-sectional dimension that is greater than a minimum cross-sectional dimension between first and third profile sections 162 and 166, as are represented in FIG. 11 by reference dimensions CD1 and CD2, respectively. Additionally, in some cases, a radially outermost point RMP of second profile sections 164 can be disposed along or radially inward of outer peripheral edge surface portion 140

Base section 104 is disposed along end 108 of traffic cone assembly 100, and includes a base wall 170 that is oriented generally transverse to longitudinal axis AX. Base wall 170 extends outwardly to an outermost peripheral edge 172, and includes a base end surface portion 174 facing toward end 106 of the traffic cone assembly. Base wall 170 also includes a base end surface portion 176 facing opposite base end surface portion 174. In some cases, base section 104 can, optionally, include one or more core cavities 178 extending into base wall 170, such as from along base end surface portion 176. If included, it will be appreciated that core cavities 178 can be of any size, shape, configuration and/or arrangement, such as may be suitable for manufacturing purposes and/or for adjusting the mass of the base section to reach a desired overall weight of traffic cone assembly 100, for example. Base section 104 is shown as having a generally square shape with outermost peripheral edge 172 including linear edge portions 180 connected by corner edge portions 182 that extend between and interconnect adjacent ones of linear edge portions 180.

Base section 104 also includes a plurality of ground-engaging feet that are disposed in spaced relation to one another around longitudinal axis AX. It will be appreciated that any suitable number, configuration and/or arrangement of ground-engaging feet can be included. In accordance with the subject matter of the present disclosure, one preferred arrangement base wall 170 includes a plurality of ground-engaging feet 184, a plurality of ground-engaging feet 186 and a plurality of ground-engaging feet 188. Feet 184 are shown as being disposed adjacent corner edge portions 182 of base section 104 and feet 186 are shown as being disposed adjacent linear edge portions 180 with each of feet 186 positioned between adjacent ones of feet 184. Feet 188 are shown as being disposed between adjacent pairs of feet 184 and 186. Feet 184 are shown as having a stadium shape (e.g., opposing parallel sides connected by semicircles) oriented radially such that the straight sides thereof are disposed in an offset radial orientation. Feet 184 extend from along base end surface 174 toward a ground-engaging surface portion 190. Feet 186 are also shown as having a stadium shape but are oriented in approximate alignment with linear edge portions 180 (e.g., in a transverse radial direction). Feet 186 extend from along base end surface 174 toward a ground-engaging surface portion 192. Feet 188 are shown as having a generally cylindrical shape, and extending from along base end surface 174 toward a ground-engaging surface portion 194.

It will be appreciated that body section 102 and base section 104 can be operatively connected to one another in any suitable manner. As one example, the body and base sections could include cooperative securement features that permit the body and base sections to be removably secured to one another. As another example, a first one of the body and base sections could be injection molded or otherwise manufactured with the other one of the body and base sections injection molded or otherwise manufactured in-situ (i.e., via a 2K or “two-shot” process) on, along, over or otherwise engaging at least a portion of the first one of the body and base sections. As still another example, a first one of the body and base sections could be injection molded or otherwise manufactured. The other one of the body and base sections could then be injection molded or otherwise manufactured on, along, over or otherwise engaging at least a portion of the first one of the body and base sections using a separate or discrete process or operation (e.g., a second molding operation).

In accordance with the subject matter of the present disclosure, base wall 170 extends around and along outer peripheral edge surface portion 140 of wall portion 132 of body wall 110. Base wall 170 also includes one or more wall portions that extend radially inward beyond outer peripheral edge surface portion 140 to substantially encapsulate at least outer peripheral edge surface portion 140 and intermediate end surface portions 146 and 148 of wall portion 132. In the exemplary arrangement shown, base wall 170 includes a wall portion 196 that extends radially inward between base end surface portion 174 and intermediate end surface portion 146 to an inner peripheral edge portion 198 that is disposed in abutting engagement with intermediate peripheral edge surface portion 150. Additionally, base wall 170 includes a wall portion 200 that extends radially inward between base end surface portion 176 and intermediate end surface portion 148 to an inner peripheral edge

Docket No. HLSM 200007US01 portion 202 that is disposed in abutting engagement with intermediate peripheral edge surface portion 152. It will be appreciated that, in a preferred arrangement, inner peripheral edge portions 198 and 202 will have shapes and/or cross-sectional profiles that are complementary to the configurations of intermediate peripheral edge surface portions 150 and 152 of wall portion 132. As a non-limiting example, inner peripheral edge portion 198 can include an approximately cylindrical shape while inner peripheral edge has a non-circular cross-sectional shape, when taken transverse to longitudinal axis AX, such that wall portion 200 extends spaces 158 along intermediate end surface portion 148 and around lobes 156. Base wall 170 can also include wall portions 204 that extend through passages 160 in wall portion 132 and operatively connect wall portions 196 and 200.

As discussed above, traffic cone assemblies are known to be used outdoors and are, thus, regularly exposed to extreme high and low temperature conditions as well as degradation due to ultraviolet light exposure and physical impacts from vehicle traffic. As such, traffic cone assemblies in accordance with the subject matter of the present disclosure have been developed that include one or more walls and/or wall portions that are at least partially formed from a polymeric composition that can include a polyvinyl chloride (PVC) polymer, which is believed to provide improved performance at extreme low temperatures while providing comparable or improved stiffness at extreme high temperatures. In particular, the polymeric composition provides mechanical properties that meet or exceed the following:

TABLE 1

| Property | Value |
|---|---|
| Tensile Strength (Ultimate) | ≥1200 PSI |
| Tensile Strength (200% Elongation) | ≥1000 PSI |
| Durometer | 75-85 Shore A |
| Ball Drop Test @ −10° F. | 2.2 pounds from 5 feet |

A traffic cone assembly in accordance with the subject matter of the present disclosure (e.g., traffic cone assembly 100) that one or more walls and/or wall portions, such as body wall 110 and/or base wall 170, for example, formed from a polymeric composition as described hereinafter meets or exceeds the criteria discussed above. As an example, testing of a wall or wall portion of traffic cone assemblies formed from the subject polymeric composition have been shown to withstand impacts from a 4.4 pound steel ball dropped from a height of 5 feet while at a temperature of approximately −10 F.

The polymeric composition includes a quantity of polyvinyl chloride polymer. Prime resin is preferred. The polymeric composition can also include a first plasticizer in an amount of 10-20 parts by weight per 100 parts by weight of polyvinyl chloride. In a preferred arrangement, the first plasticizer can be dioctyl phthalate in an amount of 15-20 parts by weight per 100 parts by weight of polyvinyl chloride. In a more preferred arrangement, the first plasticizer can be dioctyl phthalate in an amount of 15-17 parts by weight per 100 parts by weight of polyvinyl chloride.

The first plasticizer, as discussed above, can be included as a primary plasticizer. The polymeric composition can also include one or more additional plasticizers to provide improved extreme low temperature performance. As such, the polymeric composition can also include a second plasticizer in an amount of 10-20 parts by weight per 100 parts by weight of polyvinyl chloride. In a preferred arrangement, the second plasticizer can be dioctyl adipate in an amount of 15-20 parts by weight per 100 parts by weight of polyvinyl chloride. In a more preferred arrangement, the second plasticizer can be dioctyl adipate in an amount of 16-18 parts by weight per 100 parts by weight of polyvinyl chloride. The polymeric composition can further include a third plasticizer in an amount of 10-20 parts by weight per 100 parts by weight of polyvinyl chloride. In a preferred arrangement, the third plasticizer can be dioctyl sebacate in an amount of 10-15 parts by weight per 100 parts by weight of polyvinyl chloride. In a more preferred arrangement, the third plasticizer can be dioctyl sebacate in an amount of 12-14 parts by weight per 100 parts by weight of polyvinyl chloride. The polymeric composition can also include a heat stabilizer in an amount of 1-5 parts by weight per 100 parts by weight of polyvinyl chloride. In a preferred arrangement, the heat stabilizer can be thiol methyl tin in an amount of 2-4 parts by weight per 100 parts by weight of polyvinyl chloride. Optionally, the polymeric composition can further include a colorant in an amount of 0.5-2 parts by weight per 100 parts by weight of polyvinyl chloride.

It will be appreciated that, in some cases, body wall 110 and base wall 170 can be formed from a substantially identical polymeric composition. In other cases, the body wall and the base wall can be formed from substantially similar polymeric compositions that differ in color, such as to produce a traffic cone assembly having a high-visibility body wall and a black base wall, for example. In still other cases, the body wall and the base wall can be formed from different polymeric compositions. It will be appreciated, however, that in addition to the mechanical interconnection between body section 102 and base section 104, which has been discuss above in detail, it is desirable for the body section and the base section to be formed from compatible materials such that chemical bonding of the materials can occur during manufacture of the subject traffic cone assemblies.

As used herein with reference to certain features, elements, components and/or structures, numerical ordinals (e.g., first, second, third, fourth, etc.) may be used to denote different singles of a plurality or otherwise identify certain features, elements, components and/or structures, and do not imply any order or sequence unless specifically defined by the claim language. Additionally, the term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of components, devices, systems, functions, steps and/or acts are inherently mutually exclusive. Furthermore, the terms “transverse,” and the like, are to be broadly interpreted. As such, the terms “transverse,” and the like, can include a wide range of relative angular orientations that include, but are not limited to, an approximately perpendicular angular orientation. Also, the terms “circumferential,” “circumferentially,” and the like, are to be broadly interpreted and can include, but are not limited to circular shapes and/or configurations. In this regard, the terms “circumferential,” “circumferentially,” and the like, can be synonymous with terms such as “peripheral,” “peripherally,” and the like.

It will be recognized that numerous different features and/or components are presented in the embodiments shown and described herein, and that no one embodiment may be specifically shown and described as including all such features and components. As such, it is to be understood that the subject matter of the present disclosure is intended to encompass any and all combinations of the different features and components that are shown and described herein, and, without limitation, that any suitable arrangement of features and components, in any combination, can be used. Thus, it is to be distinctly understood claims directed to any such combination of features and/or components, whether or not specifically embodied herein, are intended to find support in the present disclosure. To aid the Patent Office and any readers of this application and any resulting patent in interpreting the claims appended hereto, Applicant does not intend any of the appended claims or any claim elements to invoke 35 U.S.C. 112(f) unless the words “means for” or “step for” are explicitly used in the particular claim.

While the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and alterations will occur to others upon reading and understandingthe preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations.

1. A traffic cone assembly having a longitudinal axis and comprising:
a first wall portion extending peripherally about said longitudinal axis and between a first end and a second end spaced longitudinally from said first end, said first wall portion disposed at an acute angle relative to said longitudinal axis such that said first wall portion includes a frustoconical outer surface portion and an inner surface portion that at least partially defines a hollow interior of said traffic cone assembly with said first wall portion comprised of:
(a) polyvinyl chloride;
(b) a first plasticizer in an amount of 10-20 parts by weight per 100 parts by weight of polyvinyl chloride;
(c) a second plasticizer in an amount of 10-20 parts by weight per 100 parts by weight of polyvinyl chloride;
(d) a third plasticizer in an amount of 10-20 parts by weight per 100 parts by weight of polyvinyl chloride;
(e) a heat stabilizer in an amount of 1-5 parts by weight per 100 parts by weight of polyvinyl chloride; and,
(f) a first colorant in an amount of 0.5-2 parts by weight per 100 parts by weight of polyvinyl chloride.

2. A traffic cone assembly according to claim 1, wherein said first plasticizer is dioctyl phthalate in an amount of 15-20 parts by weight per 100 parts by weight of polyvinyl chloride.

3. A traffic cone assembly according to claim 2, wherein said first plasticizer is dioctyl phthalate in an amount of 15-17 parts by weight per 100 parts by weight of polyvinyl chloride.

4. A traffic cone assembly according to claim 1, wherein said second plasticizer is dioctyl adipate in an amount of 15-20 parts by weight per 100 parts by weight of polyvinyl chloride.

5. A traffic cone assembly according to claim 4, wherein said second plasticizer is dioctyl adipate in an amount of 16-18 parts by weight per 100 parts by weight of polyvinyl chloride.

6. A traffic cone assembly according to claim 1, wherein said third plasticizer is dioctyl sebacate in an amount of 10-15 parts by weight per 100 parts by weight of polyvinyl chloride.

7. A traffic cone assembly according to claim 6, wherein said third plasticizer is dioctyl sebacate in an amount of 12-14 parts by weight per 100 parts by weight of polyvinyl chloride.

8. A traffic cone assembly according to claim 1, wherein said heat stabilizer is thiol methyl tin in an amount of 2-4 parts by weight per 100 parts by weight of polyvinyl chloride.

9. (canceled)

10. (canceled)

11. A method of manufacturing a traffic cone assembly, said method comprising:
providing a first mold body with a longitudinal axis, said first mold body including a first mold cavity defined by a first tooling surface shaped to provide a first wall portion extending between a first end and a second end spaced longitudinally from said first end, said first wall portion disposed at an acute angle relative to said longitudinal axis such that said first wall portion includes a frustoconical outer surface portion and an inner surface portion that at least partially defines a hollow interior of said first wall portion;
introducing a first material composition into said first mold cavity to at least partially form said first wall portion with said first material composition comprised of:
(a) polyvinyl chloride;
(b) a first plasticizer in an amount of 10-20 parts by weight per 100 parts by weight of polyvinyl chloride;
(c) a second plasticizer in an amount of 10-20 parts by weight per 100 parts by weight of polyvinyl chloride;
(d) a third plasticizer in an amount of 10-20 parts by weight per 100 parts by weight of polyvinyl chloride;
(e) a heat stabilizer in an amount of 1-5 parts by weight per 100 parts by weight of polyvinyl chloride; and,
(f) a first colorant in an amount of 0.5-2 parts by weight per 100 parts by weight of polyvinyl chloride; and,
removing said first wall portion from said mold cavity.

12. A method according to claim 11, wherein introducing said first material composition includes introducing dioctyl phthalate in an amount of 15-20 parts by weight per 100 parts by weight of polyvinyl chloride as said first plasticizer.

13. A method according to claim 12, wherein introducing said first material composition includes introducing dioctyl phthalate in an amount of 15-17 parts by weight per 100 parts by weight of polyvinyl chloride as said first plasticizer.

14. A method according to claim 11, wherein introducing said first material composition includes introducing dioctyl adipate in an amount of 15-20 parts by weight per 100 parts by weight of polyvinyl chloride as said second plasticizer.

15. A method according to claim 14, wherein introducing said first material composition includes introducing dioctyl adipate in an amount of 16-18 parts by weight per 100 parts by weight of polyvinyl chloride as said second plasticizer.

16. A method according to claim 11, wherein introducing said first material composition includes introducing dioctyl sebacate in an amount of 10-15 parts by weight per 100 parts by weight of polyvinyl chloride as said third plasticizer.

17. A method according to claim 16, wherein introducing said first material composition includes introducing dioctyl sebacate in an amount of 12-14 parts by weight per 100 parts by weight of polyvinyl chloride as said third plasticizer.

18. A method according to claim 11, wherein introducing said first material composition includes introducing thiol methyl tin in an amount of 2-4 parts by weight per 100 parts by weight of polyvinyl chloride as said heat stabilizer.

19. A method according to claim 11 further comprising:
providing a second mold body with a longitudinal axis, said second mold body including a second mold cavity defined by a second tooling surface shaped to provide a second wall portion oriented transverse to said longitudinal axis and extending outwardly to an outer peripheral edge;
introducing a second material composition into said second mold cavity to at least partially form said second wall portion around said first wall portion with said second material composition comprising polyvinyl chloride.

20. A method according to claim 19 further comprising positioning said first wall portion within said second mold cavity prior to introducing said second material composition.

21. A traffic cone assembly comprising:
a body section having a longitudinal axis and including a body wall extending longitudinally between a first end and a second end, said body wall including:
a first wall portion disposed along said first end and including a first outer surface portion at least partially defining a grasping area of said body section;
a second wall portion extending from along said first wall portion toward said second end at an acute angle relative to said longitudinal axis such that said second wall portion includes a frustoconical outer surface portion and a frustoconical inner surface portion that at least partially defines an interior cavity of said body section; and,
a third wall portion extending radially outward from said second wall portion along said second end to an outer peripheral edge surface portion, said third wall portion including:
a first end surface portion facing toward said first end;
a second end surface portion facing toward said second end;
a first intermediate end surface portion facing toward said first end that is offset from said first end surface portion in a direction toward said second end surface portion; and,
a second intermediate end surface portion facing toward said second end that is offset from said second end surface portion in a direction toward said first end surface portion; and,
a base section including a base wall including a first base end surface facing toward said first end of said body section and a second base end surface facing away from said first end of said body section, said base wall extending outward to an outermost peripheral edge and including a first base wall portion extending along said first intermediate end surface portion of said body wall and a second base wall portion extending along said second intermediate end surface portion of said body wall such that at least part of said third wall portion of said body wall is substantially encapsulated by said base wall thereby operatively connecting said base section to said body section.

22. A traffic cone assembly according to claim 21, wherein said third wall portion includes a first intermediate peripheral edge surface portion disposed inward of said outer peripheral edge surface portion extending from along said first end surface portion toward said first intermediate end surface portion, and said first base wall portion extends inwardly along said first intermediate end surface portion of said body wall into abutting engagement with said first intermediate peripheral edge surface portion.

23.-40. (canceled)
